(19) United States
(12) Patent Application Publication
(10) Pub. No.: US 2008/0120636 A1
(43) Pub. Date: May 22, 2008

(54) Method and System for User Customizable Rating of Audio/Video Data

(75) Inventor: Roger D. Gahman, Telford, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/561,121

(22) Filed: Nov. 17, 2006

(51) Int. Cl. H04N 7/16

(52) U.S. Cl. 725/28

(57) ABSTRACT

A method and system allows a user to provide a customized list of user defined words which are used to provide a rating to audio/video data. The user provides the user defined words to an electronic device that stores the user defined words. The electronic device searches the audio/video content and compares the audio data of the content to the user defined words. A number of instances in which the user defined words occur in the content is determined and a rating may be assigned to the content based on predetermined rating thresholds.

### FIELD OF THE INVENTION

The present invention generally relates to audio/video data, and more specifically, to a method and system for enabling a user to provide their own rating to the audio/video data.

### BACKGROUND OF THE INVENTION

With an increase in the need for entertainment and information, a large segment of the population requires access to a wide variety of media content in various forms, including movies, television programs, web-pages, and the like. Media content can include audio or audio/video data, which can be accessed by people or a group of people. Media content is available to the public through various sources such as video-on-demand, Compact Discs (CDs) and Digital Video Discs (DVDs). Recently, there has been a rise in the amount of objectionable content released, for example, on DVDs, and broadcasted via broadcasting channels. Children being exposed to inappropriate audio/video data, such as violence, and objectionable language in media content, are a major concern for parents. The negative effect of objectionable and offensive language is also a matter of serious concern among parents. Therefore, media products such as movies, televisions programs, web pages, and the like, need to be categorized to prevent children from viewing objectionable content. This categorization will help parents to decide whether a movie/program is suitable for their children.

There exist a number of techniques for categorizing media content or audio/video data. According to one such technique, a ratings board gives a rating to audio/video data, indicating the type or grade of inappropriate or objectionable content contained in it. Typically, all movies are rated before they are released. A DVD or a Video Home System (VHS) release, or any other media format, may be rated separately. However, the rating given by a ratings board does not provide users with the flexibility of rating media content according to their preferences. For example, some words, such as the word “duffer”, may be objectionable to a user but not to the ratings board. As a result, the ratings board may give a rating to the media content independent of the words objectionable to the user. Further, the use of certain symbols by various ratings boards for different categories of media content can be confusing.

### BRIEF DESCRIPTION OF THE FIGURES

The accompanying figures, where like reference numerals refer to identical or functionally similar elements throughout the separate views, and which, together with the detailed description below, are incorporated in and form a part of the specification, serve to further illustrate various embodiments and to explain various principles and advantages, all in accordance with the present invention.

FIG. 1 illustrates an exemplary environment where the present invention can be practiced;

FIG. 2 illustrates a block diagram of an exemplary electronic device, in accordance with the present invention;

FIG. 3 is flow diagram illustrating a method for customizing a list of user defined words, in accordance with the present invention;

FIG. 4 is a flow diagram illustrating a method for a user customizable rating of audio/video data, in accordance with the present invention;

FIG. 5 illustrates an exemplary report, in accordance with the present invention; and

FIG. 6 illustrates a block diagram of an exemplary architecture in accordance with a second embodiment of the invention.

Skilled artisans will appreciate that elements in the figures are illustrated for simplicity and clarity and have not necessarily been drawn to scale.

### DETAILED DESCRIPTION

Before describing in detail the particular method and system for analyzing audio/video data, in accordance with various embodiments of the present invention, it should be observed that the present invention resides primarily in combinations of method steps and apparatus components related to the method and system for analyzing audio/video data. Accordingly, the apparatus components and method steps have been represented where appropriate by conventional symbols in the drawings, showing only those specific details that are pertinent for an understanding of the present invention, so as not to obscure the disclosure with details that will be readily apparent to those with ordinary skill in the art, having the benefit of the description herein.

A method for analyzing audio/video data is provided. The method includes identifying one or more end-user-defined words in the audio/video data. Further, the method includes determining a number of instances of the one or more end-user-defined words in the audio/video data.

Another example consists of a set-top Digital Video Recorder (DVR) based unit where all of the processing is performed on locally stored content. The set-top DVR based unit receives audio/video data from a media input and stores it in a local storage. In one implementation, an interactive application using a user interface enables a user to specify words of interest using a remote control to select letters similar to existing guide based title searches, where the user uses the arrow keys to cycle through the alphabet. The user can then select among stored list of user defined words and stored audio/video data to run a report, which processes the audio/video data and list of user defined words through a processor and a memory module and outputs the results through a user interface.

Alternative user interface implementations include a wired or wireless keyboard, a mouse or a phone. Possible wireless technologies include Radio Frequency (RF), Infrared (IR), Bluetooth, Wi-Fi, and the like.

Another example of the invention consists of a set-top based local device that is used to define the user defined words and a remote processing device connected via a network where all of the processing is performed remotely at a Multiple Services Operator (MSO) location using a Video-on-demand (VOD) library of media content. The set-top based local device uses an interactive application using a User Interface (UI) that allows the user to specify words of interest using the remote control to select letters similar to existing guide based title searches, where the user uses the arrow keys to cycle through the alphabet. The user can then select among locally stored word lists and remotely stored media to run the report. The set-top based local device sends a request to the remote processing device with the user defined words, which processes the media and the list of user defined words through a processor and memory module and returns the results to the UI on the set-top based local device.

A computer program product, for use with a computer, is described. The computer program product includes a computer usable medium with a computer readable program code for analyzing audio/video data. The computer program code includes instructions for identifying one or more end-user-defined words in the audio/video data. The computer program code also includes instructions for determining a number of instances of the one or more end-user-defined words in the audio/video data.

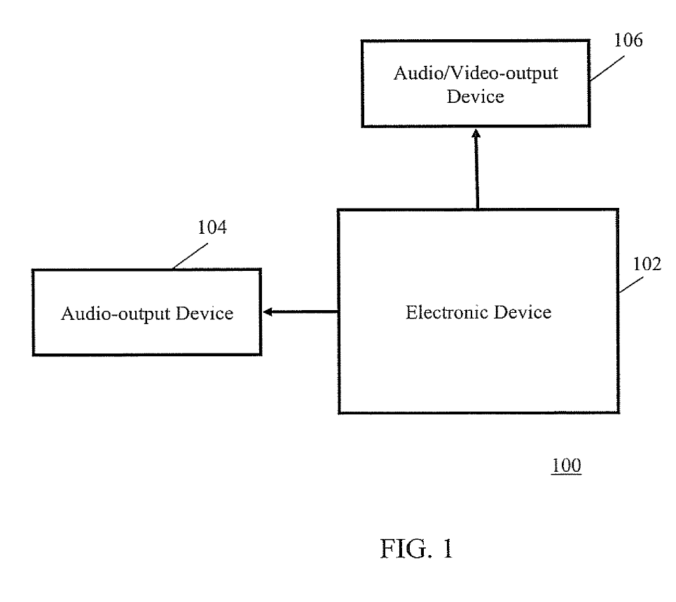

FIG. 1 illustrates an exemplary environment 100, where the present invention can be practiced. The environment 100 includes an electronic device, an audio-output device and an audio/video-output device. For the purpose of this description, the environment 100 is shown to include an electronic device 102, an audio-output device 104, and an audio/video-output device 106. Examples of the electronic device 102 include, but are not limited to, a cable network set-top box, an Integrated Receiver/Decoder (IRD), a digibox, a set-top Digital Video Recorder (DVR) based unit, a Peripheral Interface Adapter (PIA), Compact Disc (CD) player, and a Digital Video Disc (DVD) player, a Video Home System (VHS) player, a Personal Computer (PC), or any form of audio/video playing device that is capable of reading and playing audio/video data from a source. The electronic device 102 can receive media content from a source of media content such as a broadcasting station, a CD and the like. The electronic device 102 can be connected to the audio-output device 104. Examples of the audio-output device 104 include, but are not limited to, a loudspeaker, a woofer, a sub-woofer, a tweeter, ear phones, and head phones. The audio-output device 104 is capable of playing and receiving audio data from the electronic device 102. For example, the audio-output device 104 can receive signals of an audio playback of a song from the electronic device 102 and provide the audio output to a user.

The electronic device 102 can also be communicably connected to the audio/video-output device 106. Examples of the audio/video-output device 106 may include a television, a multimedia projector, a display monitor of a computer, and the like. The audio/video-output device 106 may receive signals of the audio/video data from the electronic device 102. The audio/video-output device 106 may decode the signals received from the electronic device 102 and play the audio and video associated with the received signals.

The electronic device 102 may also interact and exchange data with the audio-output device 104 and the audio/video-output device 106 simultaneously. For example, the electronic device 102 may send the audio data of a film to the audio-output device 104, to play the audio data and simultaneously send the video data to the audio/video-output device 106.

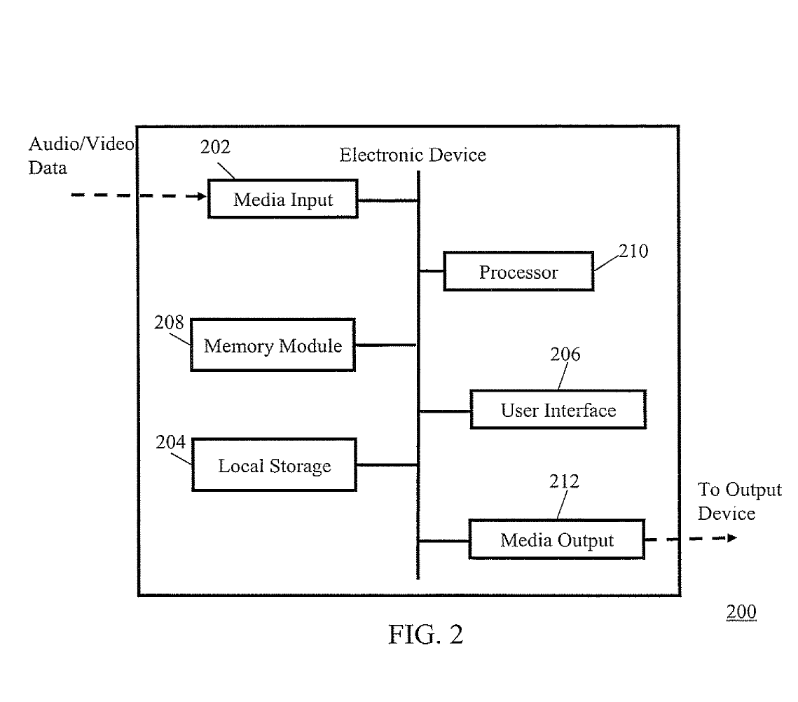

FIG. 2 illustrates a block diagram of an exemplary electronic device 200, in accordance with the present invention. The electronic device 200 includes a media input 202, a local storage 204, a User Interface 206, a memory module 208, a processor 210 and a media output 212. The electronic device 200 is configured to receive audio/video data from a source of media content. For example, the source of the media content can be a broadcasting station, a CD, a VHS (cassette), a DVD, and the like. The media input 202 is capable of receiving media and recording it to the local storage 204. Examples of the local storage 204 may include a hard disk, a magnetic tape, optical storage devices, semiconductor storage devices and the like. The electronic device 200 can also include an optical disc reader that is capable of interpreting data from a source such as an optical compact disc.

The user interface 206 enables a user to input one or more end-user-defined words that he/she may consider objectionable. Examples of the user interface 206 may include but are not limited to a keyboard, a Command Line Interface (CLI) or a Text User Interface that may be used to key in or punch in the one or more end-user-defined words through a typing-pad, and the like. Further, the user interface 206 may be configured to enable a user to customize a list of user defined words containing the one or more end-user-defined words. For example, the user can add, append, modify, delete, supplement, edit, erase, alter and change the one or more end-user-defined words in the list of user defined words through the user interface 206. Further, the user interface 206 provides the list of user defined words to the memory module 208.

The memory module 208 is configured to store the one or more end-user-defined words in the form of the list of user defined words. Further, the memory module 208 is coupled to the processor 210. The processor 210 can retrieve the one or more end-user-defined words from the memory module 208. Further, the processor 210 is coupled to the local storage 204. Furthermore, the processor 210 is capable of analyzing the audio/video data stored in the local storage 204, based on the one or more end-user-defined words.

The processor 210 can scan the list of user defined words and the audio/video data to identify the one or more end-user-defined words in the audio/video data. The processor 210 can compare the audio/video data with the list of user defined words to determine the number of instances of the one or more end-user-defined words in the audio/video data. Determining the number of instances of the one or more end-user-defined words can include counting occurrences of the one or more end-user-defined words in the audio/video data. The processor 210 is configured to count the occurrences of the one or more end-user-defined words in the audio/video data, to determine the number of times these words occurred in the audio/video data. The processor 210 may add the occurrences of the one or more end-user-defined words in the audio/video data, to determine a total number of times all of the end-user-defined words stored in the list of user defined words occurred in the audio-video data. The processor 210 may also be configured to provide a rating to the audio/video data, based on the number of instances of the one or more end-user-defined words that are found in the audio/video data and one or more predetermined rating thresholds. For instance, a rating of “not suitable for child under 5 years old” may be assigned when a single instance of an objectionable word is found, and a rating of “not suitable for child under 10 years old” may be assigned when ten instances of the objectionable words are found. The processor 210 may also generate a report, based on the number of instances of the one or more end-user-defined words in the audio/video data. The report can be provided to a user through a user interface 206 or media output 212, such as by being displayed on a television.

Moreover, the processor 210 is communicably coupled to the media output 212, which provides the audio/video data to an output device, for example, the audio-output device 104 or the audio/video-output device 106.

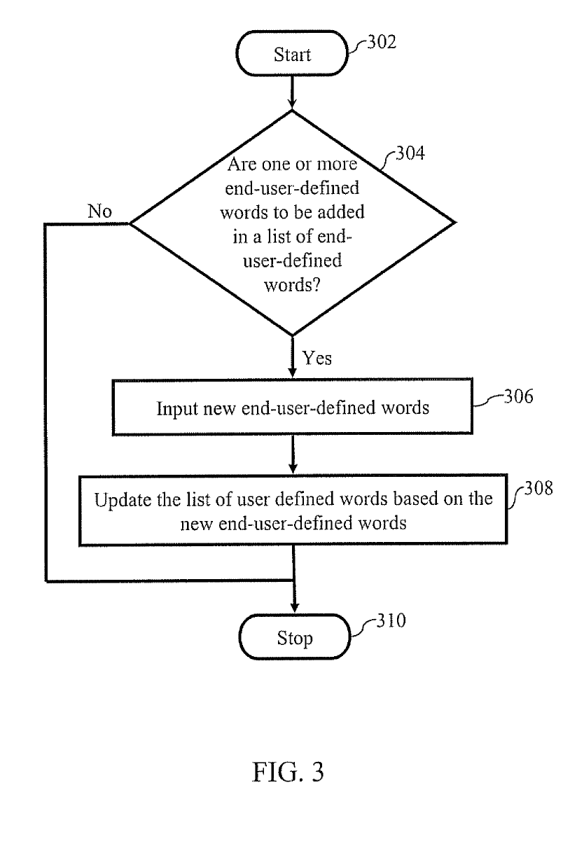

FIG. 3 is a flow diagram illustrating a method for customizing a list of user defined words, in accordance with the present invention. The list of user defined words is customized based on end-user preferences. The list of user defined words includes the one or more end-user-defined words. These one or more end-user-defined words are used to identify objectionable or inappropriate words in an audio/video data. The method for customizing the list of user defined words is initiated at step 302. At step 304, it is determined whether one or more new end-user-defined words need to be added to an existing list of user defined words. For example, the existing list of user defined words may not be comprehensive enough for the user, or he/she may notice a new word that is objectionable and inappropriate and needs to be identified while scanning the audio/video data. The user can add the new end-user-defined words to the existing list of user defined words. At step 306, the new end-user-defined words are provided as an input if it is determined at step 304 that there are new end-user-defined words that need to be added to the list of user defined words.

The new end-user-defined words can be provided as an input by using a User Interface (UI). For example, the user can add a new word, e.g. “stupid”, to the existing list of user defined words at step 306. The user can either type or key-in the new word, “stupid”, by using a keyboard or inputting the new word by using an alternative UI, such as a remote control. A user may also add the new end-user-defined words to the list of user defined words by using a microphone. At step 308, the list of user defined words is updated, based on the new end-user-defined words. For example, the new word, “stupid”, is added to the list of user defined words and at step 310, the method for customizing the list of user defined words is terminated.

Though the process of customizing the list of user defined words is explained by adding a new word to the list, it will be apparent to a person ordinarily skilled in the art that a user can also modify, append, erase, edit, delete, alter, supplement or change new or existing words in the list of user defined words, to customize the list.

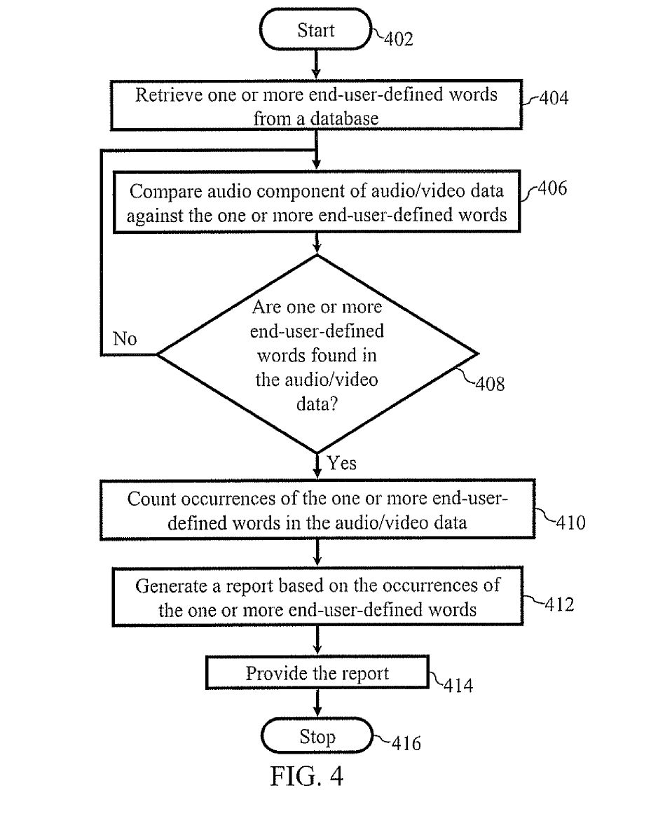

FIG. 4 is a flow diagram illustrating a method for a user customizable rating of audio/video data, in accordance with the present invention. At step 402, the method for a user customizable rating of audio/video data is initiated. At step 404, one or more end-user-defined words are retrieved from a database. For example, a list of user defined words can be stored in the database. This list of user defined words includes the one or more end-user-defined words. The database can be a memory module, for example, the memory module 208. At step 406, an audio content of the audio/video data is compared with the one or more end-user-defined words. For example, the audio content of a film are scanned and compared against the list of user defined words containing the one or more end-user-defined words. The audio content of the audio/video data is compared with the list of user defined words to identify the one or more end-user-defined words in the audio/video data. Preferably, pre-existing text data, which is associated with the audio content, such as closed captioning and/or Teletext™ data, is used in the comparison. Alternatively, the audio content may be converted into text format for the comparison by using an audio to text conversion process, such as one provided under the brand name Dragon Naturally Speaking by Nuance Communications, Inc.

At step 408, it is determined if the one or more end-user-defined words are found in the audio/video data. If it is determined at step 408 that the one or more end-user-defined words have not been found in the audio/video data, step 406 is performed again. At step 410, the occurrences of the one or more end-user-defined words are counted if it is determined at step 408 that these words have been found in the audio/video data. The occurrences of the one or more end-user-defined words are counted to determine the number of times these words occurred in the audio/video data. The occurrences of all of the end-user-defined words may be added to determine the number of times these words occurred in the audio/video data. For example, a counter can be maintained for all the words in the list of user defined words. The counter is increased by one when a similar word is identified in the audio/video data.

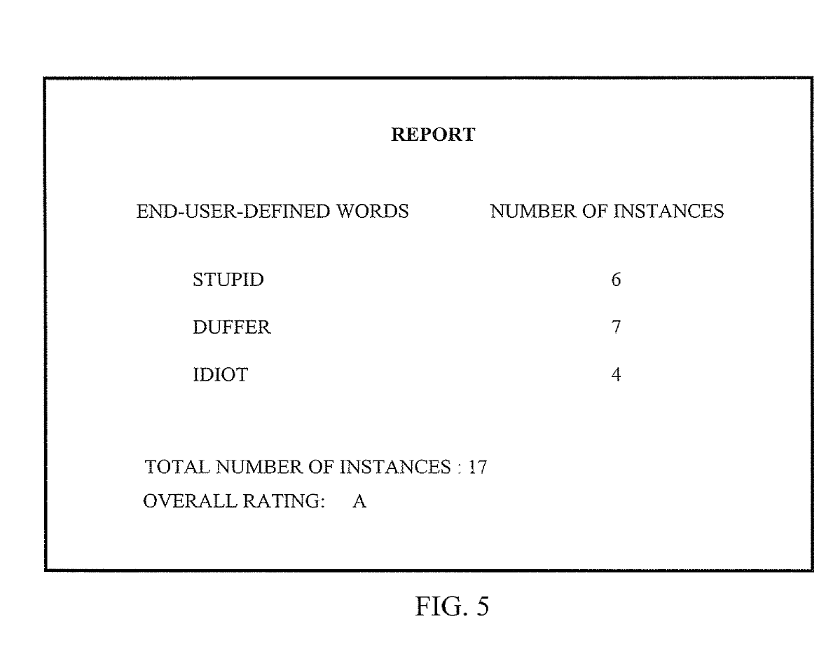

At step 412, a report is generated, based on the occurrences of the one or more end-user-defined words. The report can contain a detailed list of the occurrences of all the end-user-defined words identified at step 408. At step 414, the report is provided to the user. The report can be a detailed list of the number of times a word occurred in the audio/video data, as shown in FIG. 5. The report can include a rating assigned to the audio/video data, based on the occurrences of the one or more end-user-defined-words present in the audio/video data and/or other parameters set by the user. A user may set predetermined rating thresholds for the number of times a particular end-user-defined word occurs or based on a total number of all of the objectionable words in the list of user defined words. If the number of occurrences of individual user defined words or a total of all of the user defined words crosses one or more predetermined rating thresholds, a designated rating is given to the audio/video data. For example, if while analyzing the audio component of a movie, the system identifies the word “idiot” as occurring six times, a rating of ‘X’ (e.g. content not suitable for 5 year old child) is assigned to the content if the predetermined rating threshold for ‘X’ is five occurrences of the word “idiot”. As another example, if the word “idiot” only occurred three times, but the total number of occurrences of all of the objectionable words exceeded a threshold of twenty for total occurrences, then the rating of ‘X’ is still assigned. Further, the rating of ‘X’ is communicated to the user. Thereafter, the method for a user customizable rating of the audio/video data is terminated at step 416.

FIG. 5 illustrates an exemplary report, in accordance with an embodiment of the present invention. The report lists end-user-defined words found in the audio/video data. Further, the report includes the number of instances of the end-user-defined words that were found in the audio/video data and the total number of times the end-user-defined words were found in the audio/video data. The report also illustrates a rating given to the audio/video data based on the total number of user defined words found and a predetermined rating threshold for the total number of user defined words.

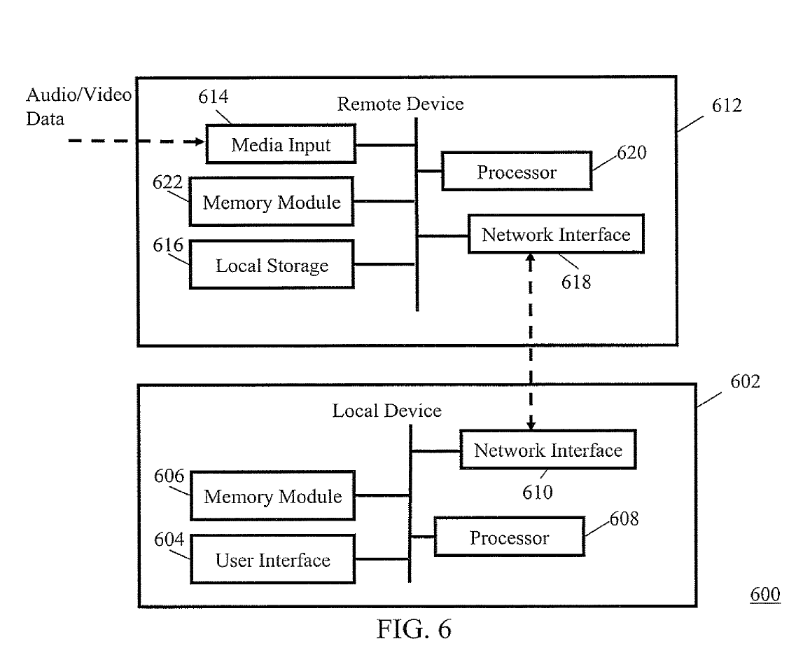

FIG. 6 illustrates a block diagram of an exemplary architecture in accordance with a second embodiment of the present invention. As illustrated in FIG. 6, a networked electronic system 600 consists of a local device 602. The local device 602 includes a user interface 604, memory module 606, a processor 608, and a network interface 610. In addition to the local device 602, the networked electronic system 600 includes a remote device 612. The remote device 612 includes a media input 614, a local storage 616, a network interface 618, a processor 620 and a memory module 622.

The local device 602 contains the user interface 604, which provides the one or more end-user-defined words to the memory module 606. The memory module 606 can store them in the form of a list of user defined words. Further, the memory module 606 is coupled to the processor 608, which can transmit the one or more end-user-defined words from the memory module 606 to the remote device 612 via the network interfaces 610. The local device 602 preferably performs the steps in FIG. 3.

The remote device 612 is configured to receive audio/video data from a source of media content. For example, the source of the media content can be a broadcasting station, a Digital Video Disc (DVD), a Video-on-demand (VOD) server and the like. The remote device 612 receives the audio/video data through the media input 614. The media input 614 is capable of receiving the audio/video data and recording it to the local storage 616. The remote device 612 preferably performs the steps in FIG. 4.

Further, the network interface 618 communicates with the network interface 610 to receive the one or more end-user-defined words from the memory module 606. Furthermore, the network interface 618 is coupled to the processor 620 and the memory module 622. Processor 620 is preferably configured to analyze the audio/video data stored in the local storage 616 or audio/video data streamed through input 614, based on the one or more end-user-defined words, preferably according to the process illustrated in FIG. 4. The resulting report is transmitted to the local device 602 via the network interfaces 610 and 618. The processor 608 stores the report in the memory module 606. The report is then available to be presented to the user via the user interface 604.

The processes in any and all of FIGS. 3 and 4 may be implemented in hard wired devices, firmware or software running in a processor. A processor for a software or firmware implementation is preferably contained the electronic device 102. Any of the processes illustrated in FIGS. 3 and 4 may be contained on a computer readable medium, which may be read by processor 210. A computer readable medium may be any medium capable of carrying instructions to be performed by a microprocessor, including a CD disc, DVD disc, magnetic or optical disc, tape, silicon based removable or non-removable memory, packetized or non-packetized wireline or wireless transmission signals. In another embodiment, processors 608 and 620 may cooperate to implement the methods of FIGS. 3 and 4 and one or more computer readable mediums may carry instructions to processors 608 and 620.

Various illustrations of the present invention offer one or more advantages. The present invention provides a method and system for analyzing audio/video data. Further, a report on the analysis is provided to a user. This report of the analyzed audio/video data is based on the one or more end-user-defined words that have been defined as offensive by the user. Consequently, the user is provided with the flexibility to analyze the audio/video data according to his/her preferences. Further, a rating can be given to the audio/video data, based on the user's preferences. For example, the audio/video data can be categorized according to the predetermined rating thresholds set by the user and the one or more end-user-defined words that have been defined as offensive by him/her. Further, a detailed list of the number of times the offensive words occurred, and/or a consolidated rating, can be given to the audio/video data. Moreover, various illustrations provide a method and system for customizing the list of offensive words and predetermined rating thresholds, based on the user's preferences.

In the foregoing specification, the invention and its benefits and advantages have been described with reference to specific examples. However, one with ordinary skill in the art would appreciate that various modifications and changes can be made, without departing from the scope of the present invention, as set forth in the claims below. Accordingly, the specification and figures are to be regarded in an illustrative rather than a restrictive sense. All such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application and all the equivalents of those claims, as issued.

What is claimed is:

1. A method for analyzing audio/video data, the method comprising:
receiving one or more end-user-defined words through a user interface;
identifying one or more end-user-defined words in the audio/video data; and
determining number of instances of the one or more end-user-defined words in the audio/video data.

2. The method as recited in claim 1 further comprising providing a rating to the audio/video data based on the number of instances of the one or more end-user-defined words in the audio/video data.

3. The method of claim 2, wherein the rating is based on a user defined threshold for the number of instances of individual end-user-defined words.

4. The method of claim 2, wherein the rating is based on a user defined threshold for a total number of instances of all of the end-user-defined words.

5. The method as recited in claim 1 further comprising:
generating a report based on the number of instances of the one or more end-user-defined words in the audio/video data; and
providing the report.

6. The method as recited in claim 1, wherein identifying the one or more end-user-defined words comprises:
converting audio content of the audio/video data into text format; and
comparing the text format of the audio content with a list of user defined words.

7. The method as recited in claim 1, wherein the step of receiving one or more end-user-defined words through a user interface includes receiving the end-user-defined words through a local user interface, and the step of identifying one or more end-user-defined words in the audio/video data includes analyzing the audio/video data at a remote location from the user interface based on the end-user-defined words.

8. An apparatus for analyzing audio/video data comprising:
a user interface capable of receiving one or more end-user-defined words; and
a processor configured to:
identify the one or more end-user-defined words in audio/video data; and
determine number of instances of the one or more end-user-defined words in the audio/video data.

9. The apparatus as recited in claim 8, wherein the processor is further configured to provide a rating to the audio/video data based on the number of instances of the one or more end-user-defined words in the audio/video data.

10. The apparatus of claim 9, wherein the rating is based on a user defined threshold for the number of instances of individual end-user-defined words.

11. The apparatus of claim 9, wherein the rating is based on a user defined threshold for a total number of instances of all of the end-user-defined words.

12. The apparatus as recited in claim 8, wherein the processor is further configured to generate a report based on the number of instances of the one or more end-user-defined words.

13. The apparatus as recited in claim 8 further comprising a memory module configured to store a list of user defined words, wherein the list of user defined words comprises the one or more end-user-defined words.

14. The apparatus as recited in claim 8, wherein the user interface includes a local user interface, and the processor includes a processor at remote location from the user interface.

15. The apparatus as recited in claim 8, wherein a local user device includes the user interface and the processor.

16. The apparatus as recited in claim 8, wherein the user interface includes at least one of: a keyboard, a Command Line Interface, a Text User Interface, or a remote control.

17. The apparatus as recited in claim 16, wherein the user interface includes displaying text on a television screen and receiving a selection of the text to generate a list of the end-user-defined words.

18. The apparatus as recited in claim 8 further comprising a media input configured to receive audio/video data and a media output configured to provide the audio/video data to an output device.

19. A computer program product for use with a computer, the computer program product comprising a computer readable medium having a computer readable program code embodied therein, for analyzing audio/video data, the computer program code performing:
receiving one or more end-user-defined words through a user interface;
identifying one or more end-user-defined words in the audio/video data; and
determining number of instances of the one or more end-user-defined words in the audio/video data.

20. The computer program product of claim 19 further performing providing a rating to the audio/video data based on the number of instances of the one or more end-user-defined words in the audio/video data.

21. The computer program product of claim 20, wherein the rating is based on a user defined threshold for the number of instances of individual end-user-defined words.

22. The computer program product of claim 20, wherein the rating is based on a user defined threshold for a total number of instances of all of the end-user-defined words.

23. The computer program product of claim 19 further performing:
generating a report based on the number of instances of the one or more end-user-defined words in the audio/video data; and
providing the report.

24. The computer program product of claim 19, wherein identifying the one or more end-user-defined words comprises:
converting audio content of the audio/video data into text format; and
comparing the text format of the audio content with a list of user defined words.

25. The computer program product of claim 19, wherein the program code for performing the step of receiving one or more end-user-defined words through a user interface is performed at a local user interface, and the program code for performing the step of identifying one or more end-user-defined words in the audio/video data is performed at a remote location from the user interface.
